(19) United States
(12) Patent Application Publication
(10) Pub. No.: US 2026/0256334 A1
(43) Pub. Date: Sep. 3, 2026

(54) CLEANING BASE STATION AND CLEANING SYSTEM

(71) Applicant: Dreame Innovation Technology (Suzhou) Co., Ltd., Suzhou (CN)

(72) Inventors: Zhenwei ZHAN, Suzhou (CN); Yinghao LIU, Suzhou (CN)

(21) Appl. No.: 19/656,678

(22) Filed: Apr. 23, 2026

Related U.S. Application Data
(63) Continuation of application No. PCT/CN2025/084124, filed on Mar. 21, 2025.

(30) Foreign Application Priority Data
Mar. 22, 2024 (CN) 202420577637.6

(51) Int. Cl. A47L 11/40; B08B 1/16; B08B 1/20; B08B 1/40

(52) U.S. Cl. CPC A47L 11/4091; B08B 1/165; B08B 1/20; B08B 1/40; A47L 2201/028

(57) ABSTRACT

A cleaning base station, configured to clean a cleaning member of a cleaning device, including a base, a cleaning tank, a collection tank, and a water scraping structure. The cleaning tank is arranged on the base and is configured to at least partially accommodate the cleaning members. A bottom wall of the cleaning tank is in contact with the cleaning member when the cleaning member is cleaned. The collection tank is in communication with the cleaning tank. The water scraping structure is arranged in the cleaning tank or the collection tank, and the collection tank is configured to receive dirt scraped off by the water scraping structure.

### CROSS-REFERENCE TO RELATED APPLICATIONS

The present application is a continuation of International Application No. PCT/CN2025/084124, filed on March 21, 2025, which claims the priority to Chinese Patent Application No. 202420577637.6, filed with the China National Intellectual Property Administration on March 22, 2024. The aforementioned applications are incorporated herein by reference in their entireties.

### TECHNICAL FIELD

The present application relates to the technical field of cleaning apparatuses, and in particular to a cleaning base station and a cleaning system.

### BACKGROUND

With the development of the economy and the continuous progress of society, smart home products have gradually entered people’s lives, providing numerous conveniences for people’s lives. Cleaning devices have offered significant assistance in household cleaning tasks, significantly reducing the labor intensity of cleaning. During operation, a cleaning device cleans the floor using a cleaning member such as mop cloth. After a period of use, the cleaning device needs to be driven into a cleaning base station, where the soiled cleaning member is washed using a cleaning tank inside the cleaning base station.

In the related art solutions, after the cleaning of the cleaning member is finished in the cleaning base station, dirt is likely to remain in the cleaning tank. The dirt remaining in the cleaning tank requires subsequent manual cleaning by a user, thereby increasing the workload of a user and affecting the user experience.

### SUMMARY

In order to overcome the above-mentioned drawbacks in the related art, an objective of the present application is to provide a cleaning base station and a cleaning system. The present application advantageously reduces the amount of dirt remaining in a cleaning tank after a cleaning member is cleaned in the cleaning base station, thereby reducing the subsequent workload of a user and facilitating an improvement in the user experience.

The present application provides a cleaning base station for cleaning a cleaning member of a cleaning device, the cleaning base station including:

a base;

a cleaning tank arranged on the base and configured to at least partially accommodate the cleaning member, a bottom wall of the cleaning tank being in contact with the cleaning member when the cleaning member is cleaned;

a collection tank, which is in communication with the cleaning tank; and

a water scraping structure arranged in the cleaning tank or the collection tank, the collection tank being configured to receive dirt scraped off by the water scraping structure.

Compared with the related art solutions, the present application raises the overall height of the cleaning tank within the base such that the bottom wall of the cleaning tank comes into contact with the cleaning member when the cleaning member is cleaned, and the cleaning member can simultaneously clean the cleaning tank during the process in which the cleaning member is rotated and cleaned within the cleaning tank. By providing the collection tank and the water scraping structure, the water scraping structure can scrape the dirt from the cleaning member into the collection tank during the process in which the cleaning member is rotated and cleaned within the cleaning tank, thereby reducing the amount of dirt remaining on the surface of the cleaning tank after the cleaning member is cleaned in the cleaning base station, reducing the subsequent workload of a user, and facilitating an improvement in the user experience.

In one possible implementation, the cleaning member is rotatable relative to the cleaning tank, at least one of the cleaning member and the cleaning tank is capable of being cleaned when the cleaning member rotates relative to the cleaning tank, and waste water on the cleaning member is scraped off by the water scraping structure.

In one possible implementation, the water scraping structure includes a water scraping plate, the water scraping plate protruding from the bottom wall of the cleaning tank and being adjacent to the collection tank.

By configuring the water scraping plate to protrude from the bottom wall of the cleaning tank, it is ensured that the water scraping plate can scrape the waste water from the cleaning member during the process in which the cleaning member is rotated and cleaned within the cleaning tank; and by arranging the water scraping plate adjacent to the collection tank, the scraped waste water can flow into the collection tank, so that the structure is simple, and is easy to implement. It is possible to promptly scrape the waste water from the cleaning member and clean the cleaning member again with clean water, thereby improving the cleaning efficiency of the cleaning member.

In one possible implementation, the water scraping plate is arranged on a side of the collection tank facing away from a rotation direction of the cleaning member, and a projection of at least a portion of the water scraping plate overlaps with a projection of the collection tank in a plane parallel to the bottom wall of the cleaning tank.

By arranging the water scraping plate on the side of the collection tank facing away from the rotation direction of the cleaning member, the water scraping plate can scrape the waste water from the cleaning member to the collection tank after contact with the rotating cleaning member, thereby facilitating the flow of the waste water into the collection tank. By arranging at least a portion of the water scraping plate within the projection of the collection tank, the water scraping plate has a portion that overlaps with the collection tank, such that the waste water scraped by the water scraping plate can fall directly into the collection tank.

In one possible implementation, the water scraping plate is connected to and integrally formed with a tank wall of the collection tank.

The integral formation of the water scraping plate and the tank wall of the collection tank can help simplify the manufacturing process and improve the production efficiency.

In one possible implementation, the water scraping plate extends in a direction perpendicular to the bottom wall of the cleaning tank.

The arrangement of the water scraping plate perpendicular to the bottom wall of the cleaning tank can ensure that the water scraping plate has a good water scraping efficiency.

In one possible implementation, the cleaning tank includes a first tank body and a second tank body arranged side by side, the collection tank is arranged between the first tank body and the second tank body, and the collection tank is in communication with both the first tank body and the second tank body.

The collection tank is arranged between the first tank body and the second tank body, to facilitate the collection of the waste water from the cleaning member located in the first tank body and from the cleaning member located in the second tank body into the collection tank.

In one possible implementation, the water scraping plate includes a first water scraping plate located on the first tank body and a second water scraping plate located on the second tank body, the collection tank includes a first tank wall and a second tank wall on a side facing away from a rotation direction of the cleaning member, the first water scraping plate is flush with the first tank wall, and the second water scraping plate is flush with the second tank wall.

The first water scraping plate can scrape the waste water from the cleaning member in the first tank body into the collection tank, and the second water scraping plate can scrape the waste water from the cleaning member in the second tank body into the collection tank.

In one possible implementation, the cleaning member includes a first cleaning member and a second cleaning member, the first cleaning member rotating clockwise and the second cleaning member rotating counterclockwise during cleaning of the cleaning members, and the first water scraping plate and the second water scraping plate are formed at a side wall of the collection tank close to an entrance of the cleaning base station.

In one possible implementation, a projection of the first tank body and a projection of the second tank body are both sector-shaped or circular in a plane parallel to the bottom wall of the cleaning tank, and at least a portion of the collection tank is located within a radial range of the first tank body and a radial range of the second tank body.

In one possible implementation, a friction member is further provided on the bottom wall of the cleaning tank, and the cleaning member is capable of contacting the bottom wall of the cleaning tank and the friction member when rotating relative to the cleaning tank.

By providing the friction member, the coefficient of friction between the cleaning member and the bottom wall of the cleaning tank can be increased, thereby improving the cleaning efficiency of the cleaning member.

In one possible implementation, the friction member includes a plurality of protrusions protruding from the bottom wall of the cleaning tank.

By uniformly arranging the plurality of protrusions on the bottom wall of the cleaning tank, the rotating cleaning member can be scrubbed with the protrusions, thereby improving the cleaning efficiency of the cleaning member.

In one possible implementation, the plurality of protrusions include a plurality of protruding points formed at the bottom wall of the cleaning tank, the plurality of protruding points being uniformly distributed over at least a portion of the bottom wall of the cleaning tank.

In one possible implementation, the cleaning base station further includes a water circuit assembly including a water inlet pipeline, the water inlet pipeline including a water inlet and a water inlet pipe, where the water inlet pipe is configured to communicate with a water source, the water inlet is formed at one end of the water inlet pipe, and the water inlet is in communication with the cleaning tank or the collection tank.

By providing the water inlet pipeline, clean water from the water source is introduced into the cleaning tank, thereby enabling the cleaning of the cleaning member.

In one possible implementation, the water inlet is located in the collection tank, a scoop wheel is rotatably provided in the collection tank, and the scoop wheel is configured to scoop water from the collection tank onto the cleaning member above the cleaning tank.

By providing the rotatable scoop wheel, the water in the collection tank is scooped onto the cleaning member by means of the scoop wheel, thereby improving the utilization rate of water, facilitating a reduction in the water consumption during cleaning of the cleaning member, and conserving water resources.

In one possible implementation, the scoop wheel includes a rotatable wheel body, the wheel body having a plurality of blades arranged in a circumferential direction, the blades being configured to be driven to rotate with a rotational movement of the cleaning member to scoop the water from the collection tank.

When the cleaning member is rotated in the cleaning tank, the scoop wheel can be driven to rotate synchronously within the collection tank. A recessed structure is formed between two adjacent blades on the scoop wheel, such that the water is scooped onto the cleaning member by means of the recessed structure between the two adjacent blades to improve the utilization rate of water.

In one possible implementation, the scoop wheel is removably arranged in the collection tank; and

the scoop wheel further includes connecting pins arranged at two axial ends of the wheel body, and the collection tank is provided with two connecting grooves arranged opposite to each other, the connecting pins being seated in the corresponding connecting grooves.

The removable arrangement of the scoop wheel in the collection tank facilitates subsequent maintenance and replacement, and also facilitates daily cleaning of the scoop wheel by the user.

In one possible implementation, the water circuit assembly further includes a drain pipeline, the drain pipeline including a drain port and a drain pipe, where the drain pipe is configured to communicate with a waste discharge device; and the drain port is formed at one end of the drain pipe, and the drain port is in communication with the collection tank.

The drain pipeline is configured to drain the waste water from the collection tank, so that the circulation of water is achieved with the incorporated water inlet pipeline.

In one possible implementation, a filter screen is further provided in the collection tank, and the filter screen is configured to cover the drain port.

By providing the filter screen, large-sized dirt particles in the waste water can be intercepted to avoid blockage of the drain pipeline.

In one possible implementation, the water inlet is arranged between the first water scraping plate and the second water scraping plate; and

the drain port is located in the collection tank on a side away from the water inlet.

The cleaning base station is provided with a clean water tank and a waste water tank, so that the circulation of water within the cleaning base station can be achieved without the need for external apparatuses.

In one possible implementation, the base is further provided with a guide plate configured to guide the cleaning member into the base; and

the water inlet is arranged to face away from the guide plate.

In one possible implementation, a projection of the water inlet is sector-shaped in a plane parallel to the bottom wall of the cleaning tank.

By configuring the water inlet to have a sector-shaped cross section, the water inlet can spray a wider surface of water, thereby flushing more areas within the collection tank. When the waste water in the collection tank is drained, the water inlet can be opened to flush the collection tank so as to clean the residual dirt in the collection tank.

In one possible implementation, the drain port is arranged on the bottom wall of the collection tank, and the bottom wall of the collection tank is inclined from the water inlet toward the drain port.

By configuring the bottom wall of the collection tank to be inclined from the water inlet toward the drain port, the waste water can flow to the drain port under the force of gravity, so that the waste water can be drained from the collection tank.

In one possible implementation, the first tank wall and the second tank wall are inclined, and a distance between the first tank wall and the second tank wall gradually increases from the water inlet to the drain port.

The first tank wall and the second tank wall are inclined and the distance between the first tank wall and the second tank wall gradually increases in the direction away from the water inlet, so that the water inlet with a sector-shaped cross section can be incorporated to further raise the water pressure sprayed into the collection tank, thereby facilitating better cleaning of the residual dirt in the collection tank.

In one possible implementation, the drain pipe is further connected to a control valve configured to control the opening and closing of the drain pipe.

The control valve controls the disconnection of the drain pipe from the waste discharge device when the cleaning member is cleaned such that the water in the collection tank is not drained. With the incorporated scoop wheel, water resources can be fully utilized, which helps to save water consumption.

In one possible implementation, the water inlet is located in the cleaning tank, and the drain port is located in the collection tank.

The water inlet pipeline and the drain pipeline of the cleaning base station can be connected to an external apparatus to achieve the circulation of water.

In one possible implementation, the friction member further includes a plurality of ribs, the ribs protruding from the bottom wall of the cleaning tank, and the water inlet is located on a side of the rib facing away from the rotation direction of the cleaning member.

By arranging the water inlet on the side of the rib facing away from the rotation direction of the cleaning member, the blockage of the water inlet can be effectively prevented, thereby ensuring that the water inlet has good water inlet capacity.

In one possible implementation, the water inlet is in the form of an elongated hole provided in the rib.

By configuring the water inlet in the form of an elongated hole, the water inlet area of the water inlet can be increased, thereby facilitating the wetting of a larger area of the cleaning member, and facilitating an improvement in the cleaning efficiency.

In one possible implementation, each of the ribs is further provided with a water guide portion, the water guide portion including a water guide bottom wall, a first water guide sidewall and a second water guide sidewall, where the first water guide sidewall and the second water guide sidewall are both located on the water guide bottom wall, a first end of the first water guide sidewall and a first end of the second water guide sidewall are close to each other, the water inlet is located between the first end of the first water guide sidewall and the first end of the second water guide sidewall, and a spacing between the first water guide sidewall and the second water guide sidewall gradually increases in a direction away from the water inlet.

Since the rib is provided with the water guide portion, and the spacing between the first water guide sidewall and the second water guide sidewall of the water guide portion gradually increases in the direction away from the water inlet, the water drained from the water inlet can be uniformly spread out by the water guide portion and then comes into contact with the cleaning member, so as to more uniformly wet the cleaning member, thereby facilitating an improvement in the cleaning efficiency.

In one possible implementation, the plurality of ribs include a plurality of first ribs located in the first tank body and a plurality of second ribs located in the second tank body, the plurality of first ribs being uniformly arranged in a circumferential direction of the first tank body, and the plurality of second ribs being uniformly arranged in a circumferential direction of the second tank body, where the first water scraping plate is arranged on the first rib on a side of the collection tank facing away from the rotation direction of the cleaning member, and the second water scraping plate is arranged on the second rib on the side of the collection tank facing away from the rotation direction of the cleaning member.

The plurality of first ribs are uniformly arranged in the first tank body, and the cleaning member in the first tank body can be uniformly supported by the plurality of first ribs, so as to prevent the cleaning member from being unevenly subjected to force. The plurality of second ribs are uniformly arranged in the second tank body, and the cleaning member in the second tank body can be uniformly supported by the plurality of second ribs, so as to prevent the cleaning member from being unevenly subjected to force.

In one possible implementation, the cleaning tank is removably arranged on the base.

The removable arrangement of the cleaning tank on the base facilitates subsequent maintenance and replacement, and also facilitates daily maintenance of the cleaning tank by the user.

In one possible implementation, the base is provided with a mounting recess, a positioning protrusion is provided in the mounting recess, and a surface of the cleaning tank facing the mounting recess is provided with a positioning groove, the positioning groove of the cleaning tank being sleeved over the positioning protrusion.

The cleaning tank can be removably arranged on the base by mating the positioning groove of the cleaning tank with the positioning protrusion of the mounting recess.

In one possible implementation, the cleaning tank is a stainless steel tank.

The stainless steel cleaning tank is resistant to dirt adhesion and facilitates easier cleaning with the cleaning member.

In another aspect, the present application provides a cleaning system, including a cleaning device and a cleaning base station as described in any one of the above items, where the cleaning device includes a first cleaning member and a second cleaning member, the first cleaning member and the second cleaning member being arranged side by side on the cleaning device.

After the cleaning device of the present application is driven into the cleaning base station, the bottom wall of the cleaning tank comes into contact with the cleaning member when the cleaning member is cleaned, and the cleaning member can simultaneously clean the cleaning tank during the process in which the cleaning member is rotated and cleaned within the cleaning tank. By providing the collection tank and the water scraping structure, the water scraping structure can scrape the dirt from the cleaning member into the collection tank during the process in which the cleaning member is rotated and cleaned within the cleaning tank, thereby reducing the amount of dirt remaining on the surface of the cleaning tank after the cleaning member is cleaned in the cleaning base station, reducing the subsequent workload of a user, and facilitating an improvement in the user experience.

### BRIEF DESCRIPTION OF DRAWINGS

In order to more clearly describe the technical solutions in the embodiments of the present application or in the related art, the accompanying drawings for describing the embodiments or the related art will be briefly described below. Apparently, the accompanying drawings in the description below show some embodiments of the present application, and those of ordinary skill in the art may still derive other drawings from these accompanying drawings without creative efforts.

FIG. 1 is a structural schematic diagram of a cleaning base station according to one embodiment of the present application.

FIG. 2 is a cross-sectional view of FIG. 1 taken along line A-A.

FIG. 3 is an exploded view of FIG. 1.

FIG. 4 is a structural schematic diagram of a cleaning tank according to one embodiment of the present application.

FIG. 5 is a structural schematic diagram of a cleaning base station according to another embodiment of the present application.

FIG. 6 is a cross-sectional view of FIG. 5 taken along line B-B.

FIG. 7 is a structural schematic diagram of a cleaning base station according to still another embodiment of the present application.

FIG. 8 is a partial enlarged view of part A in FIG. 7.

List of reference signs:

1000 - cleaning base station;

100 - base; 110 - mounting recess; 120 - positioning protrusion;

200 - cleaning tank; 201 - first tank body; 202 - second tank body; 210 - bottom wall of cleaning tank; 220 - positioning column;

300-water scraping structure-310-first scraping plate-320-second scraping plate

300 - water scraping structure; 310 - first water scraping plate; 320 - second water scraping plate;

400 - collection tank. 401 - first tank wall. 402 - second tank wall. 403 - bottom wall collection tank. 410 - scoop wheel 411 - wheel body 412 - connecting pin 420 - connecting groove 410 - filter screen

510 -protrusion, 520 rib, 521 - first rib, 522 second rib, 530 water guide portion, 531 - water guide bottom wall, 532 - first water guide sidewall , 533 - second water guide sidewall

600 -water intel pipeline, 610 water intel, 620 water intel pipe

700 - drain pipeline, 710 - drain port, 720 - drain pipe

### DESCRIPTION OF EMBODIMENTS

In order to make the objectives, technical solutions and advantages of embodiments of the present application clearer, the technical solutions in the embodiments of the present application will be described clearly and completely below with reference to the accompanying drawings in the embodiments of the present application. Apparently, the embodiments described are some of, rather than all of, the embodiments of the present application.

All other embodiments obtained by a person of ordinary skill in the art based on the embodiments of the present application without creative efforts shall fall within the scope of protection of the present application. The following embodiments and features in the embodiments may be mutually combined in case of no conflict.

As described in the background art, in the related art solutions, after the cleaning of the cleaning member of the cleaning device is finished in the cleaning base station, dirt is likely to remain in the cleaning tank. The dirt remaining in the cleaning tank requires subsequent manual cleaning by a user, thereby increasing the workload of a user and affecting the user experience.

In the related art solutions, a cleaning tank and a water supply and drainage apparatus are provided on a base of the cleaning base station, where the cleaning tank is provided with a plurality of raised ribs; and after the cleaning device is driven into the cleaning base station, the water supply and drainage apparatus supplies water to the cleaning member, and the cleaning device rotates the cleaning member, to cause the cleaning member to contact the raised ribs so as to clean the cleaning member. The waste water after cleaning is then drained from the cleaning tank by means of the water supply and drainage apparatus. It has been found by the inventors that in the related art solutions, when the cleaning member of the cleaning device is cleaned in the cleaning base station, the cleaning member is in contact with the raised ribs in the cleaning tank during rotation, and the dirt on the cleaning member is scraped by the raised ribs and remains with the waste water in the cleaning tank. When the waste water is drained, part of the dirt is drained with the waste water from the cleaning tank, while the other part of the dirt is deposited on the surface of the cleaning tank. As the number of uses increases, the accumulation of dirt deposited on the surface of the cleaning tank increases, so that the user has to regularly clean the dirt in the cleaning tank, thereby increasing the workload of the user, and resulting in a poor user experience.

In other related art, in order to solve the above problems, a special cleaning component may be provided in the cleaning base station to clean the base station, but the provision of the cleaning component may require the introduction of a new driving structure and a new cleaning structure, so that the complexity and cost of the cleaning base station are increased, and the reliability of use needs to be improved.

In view of this, the embodiments of the present application are directed to providing a cleaning base station and a cleaning system, in which the overall height of a cleaning tank within a base of the cleaning base station is raised, a collection tank is provided in the cleaning tank, and an edge of the collection tank is provided with a water scraping structure, such that when a cleaning member of a cleaning device is cleaned in the cleaning base station, the cleaning member can directly contact a bottom wall of the cleaning tank, and the cleaning member can simultaneously clean the cleaning tank during the process in which the cleaning member is rotated and cleaned within the cleaning tank. The water scraping structure is used to scrap dirt from the cleaning member to the collection tank, to reduce the dirt remaining on the surface of the cleaning tank after the cleaning of the cleaning member is finished in the cleaning base station, thereby facilitating a reduction in the subsequent workload of the user and improving the user experience. No additional cleaning components need to be provided for the cleaning tank, which otherwise results in unnecessary structural complexity, thereby avoiding increased manufacturing costs.

The content of the embodiments of the present application will be described in detail below with reference to the accompanying drawings, so that those skilled in the art can understand the content of the present application in more detail.

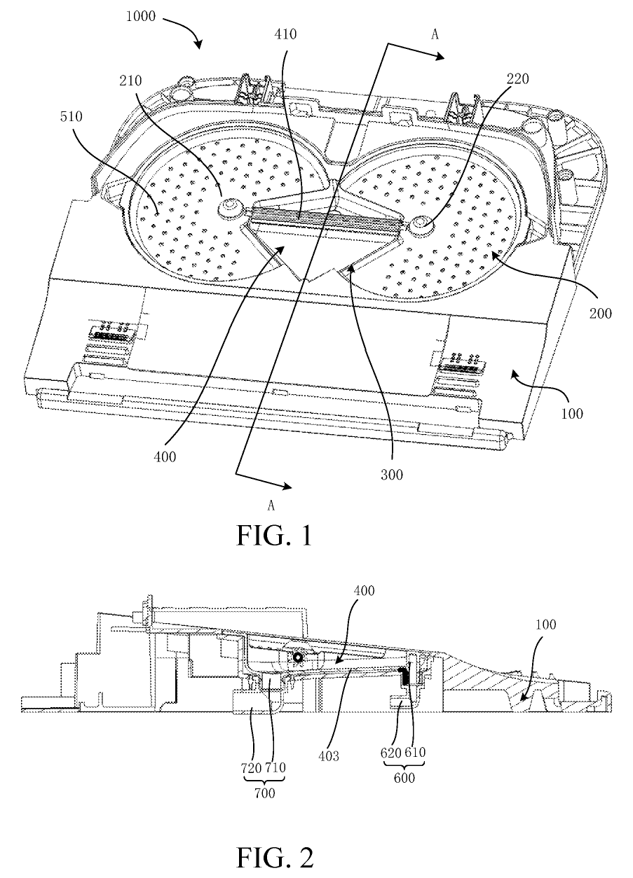

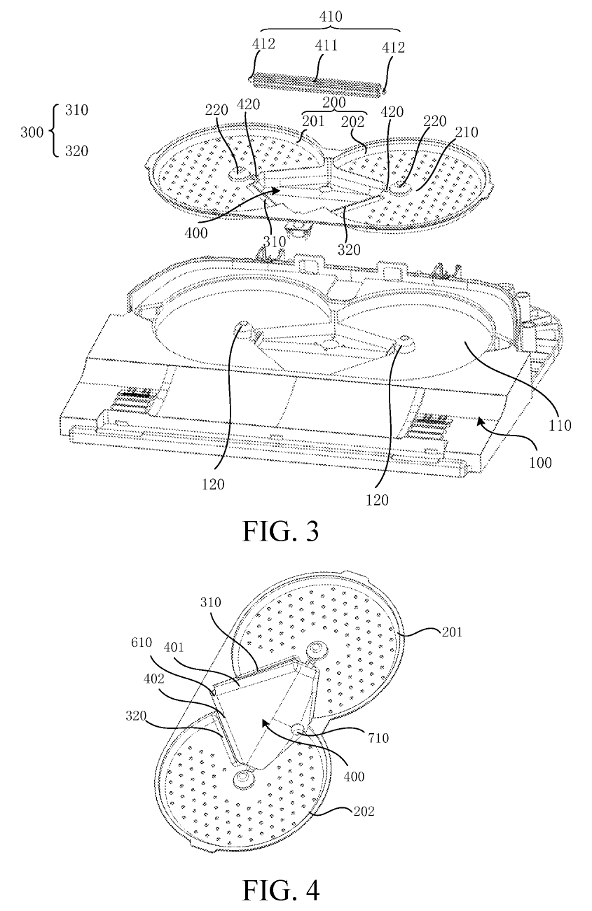

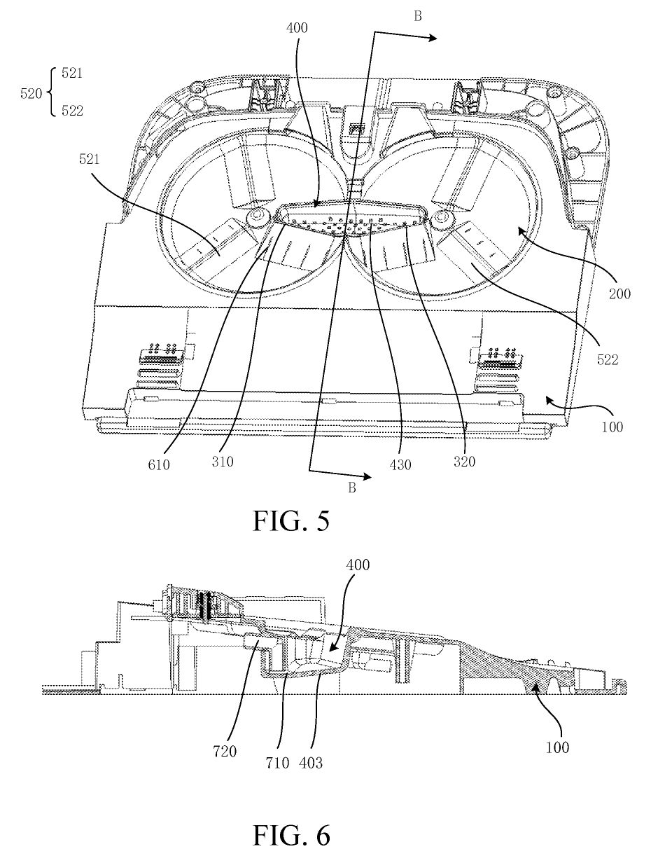

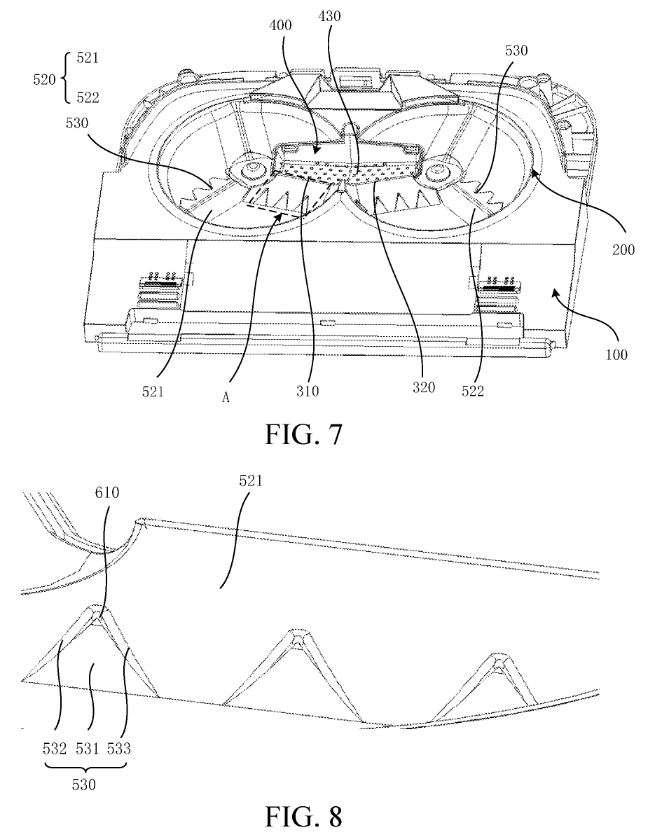

FIG. 1 is a structural schematic diagram of a cleaning base station 1000 according to one embodiment of the present application; FIG. 2 is a cross-sectional view of FIG. 1 taken along line A-A; FIG. 3 is an exploded view of FIG. 1; FIG. 4 is a structural schematic diagram of a cleaning tank according to one embodiment of the present application; FIG. 5 is a structural schematic diagram of a cleaning base station 1000 according to another embodiment of the present application; FIG. 6 is a cross-sectional view of FIG. 5 taken along line B-B; FIG. 7 is a structural schematic diagram of a cleaning base station 1000 according to still another embodiment of the present application; and FIG. 8 is a partial enlarged view of part A in FIG. 7.

Referring to FIGS. 1-8, this embodiment provides a cleaning base station 1000 for cleaning a cleaning member of a cleaning device. The cleaning device may be, for example, a cleaning robot, such as sweeping robot, a mopping robot, and a sweeping and mopping integrated robot. The corresponding cleaning member may be, for example, a sweeping brush or a mop.

The cleaning base station 1000 may be placed on the floor of the user’s home, and the cleaning base station 1000 includes a base 100. The base 100 is the portion of the cleaning base station 1000 that is in contact with the floor. To facilitate the entrance of the cleaning device into the cleaning base station 1000, a ramp-like guide plate may be further connected to the base 100, along which the cleaning device may travel to the base 100. It will be appreciated that other components of the cleaning base station 1000 are not shown in the figures of this embodiment.

A cleaning tank 200 is provided on the base 100 of this embodiment. The cleaning tank 200 is configured to accommodate the cleaning member. In general, the cleaning tank 200 is shaped to be adapted to the shape of the cleaning member, for example, may be in the form of a disk. The cleaning tank 200 may contain clean water, or the clean water may be injected into cleaning tank 200 by means of other components of the cleaning base station 1000. When the cleaning device enters the cleaning base station 1000, the cleaning device may drive the cleaning member to rotate, and the cleaning member rubs against the cleaning tank 200 during rotation, thereby removing dirt from the cleaning member. By way of example, in this embodiment, the cleaning tank 200 within the base 100 may be raised by changing a connection structure between the base 100 and the cleaning tank 200. For example, the cleaning tank 200 within the base 100 is raised by providing a support member below the cleaning tank. Compared with the solutions in the related art, since the bottom wall of the cleaning tank 200 is raised, the bottom wall 210 of the cleaning tank comes into contact with the cleaning member when the cleaning member is cleaned, so that the bottom wall 210 of the cleaning tank can be cleaned simultaneously by using the cleaning member. In this embodiment, the base 100 is further provided with a collection tank 400 which is in communication with the cleaning tank 200, and a water scraping structure 300 is further provided in the cleaning tank 200 or the collection tank 400. The water scraping structure 300 can scrape the waste water from the cleaning member, and the collection tank 400 is configured to receive the dirt scraped off by the water scraping structure 300.

Compared with the related art solutions, this embodiment raises the overall height of the cleaning tank 200 within the base 100 such that the bottom wall 210 of the cleaning tank comes into contact with the cleaning member when the cleaning member is cleaned, and the cleaning member can simultaneously clean the cleaning tank 200 during the process in which the cleaning member is rotated and cleaned within the cleaning tank 200. By providing the collection tank 400 and the water scraping structure 300, the water scraping structure 300 can scrape the dirt from the cleaning member into the collection tank 400 during the process in which the cleaning member is rotated and cleaned within the cleaning tank 200, thereby reducing the amount of dirt remaining on the surface of the cleaning tank 200 after the cleaning member is cleaned in the cleaning base station 1000, reducing the subsequent workload of a user, and facilitating an improvement in the user experience. The cleaning base station 1000 of this embodiment has a simple structure and is easy to implement, and the components of the cleaning tank 200 are simple, thereby avoiding residual stains and cleaning blind spots.

Specifically, in this embodiment, the cleaning member can rotate relative to the cleaning tank 200, at least one of the cleaning member and the cleaning tank 200 can be cleaned when the cleaning member rotates relative to the cleaning tank 200, and waste water on the cleaning member is scraped off by the water scraping structure 300.

With the above structure, this embodiment can clean the cleaning tank 200 by rotating the cleaning member within the cleaning tank 200, thereby reducing the dirt remaining on the surface of the cleaning tank 200 after the cleaning of the cleaning member is finished in the cleaning base station 1000; and the water scraping structure 300 can scrape the waste water from the cleaning member, and thus enables cleaning of the cleaning member. The cleaning of the cleaning member and the cleaning of the cleaning tank are achieved by the rotational movement of the cleaning member itself, so that the structure is easy to implement.

In some embodiments, the water scraping structure 300 of this embodiment includes a water scraping plate. The water scraping plate protrudes from the bottom wall 210 of the cleaning tank, and the water scraping plate may be a flat plate. In an embodiment, the water scraping plate may be arranged obliquely or vertically on the bottom wall 210 of the cleaning tank, and the water scraping plate is arranged adjacent to the collection tank 400.

For example, the water scraping plate may be a flat plate arranged vertically on the bottom wall 210 of the cleaning tank; or may be a flat plate arranged vertically on the bottom wall of the collection tank 400, with a portion of the water scraping plate protruding from the bottom wall 210 of the cleaning tank.

By the water scraping plate being arranged adjacent to the collection tank 400, it is meant that the water scraping plate may be integrally formed with the collection tank 400. Alternatively, the water scraping plate may be located at a distance from the collection tank 400. The specific value of this distance can be set as needed. The appropriate distance should be set such that the waste water scraped off by the water scraping plate can be collected by the collection tank 400. For example, the water scraping plate may be arranged obliquely on the bottom wall 210 of the cleaning tank, and the end of the water scraping plate away from the bottom wall 210 of the cleaning tank may extend above the collection tank 400, thereby facilitating scraping of waste water from the cleaning member into the collection tank 400.

Since the bottom wall 210 of the cleaning tank is in contact with the cleaning member during cleaning of the cleaning member in this embodiment, configuring the water scraping plate to protrude from the bottom wall 210 of the cleaning tank can ensure that the water scraping plate can scrape the waste water from the cleaning member during the process in which the cleaning member is rotated and cleaned within the cleaning tank 200. Moreover, by arranging the water scraping plate adjacent to the collection tank 400, the scraped waste water can flow into the collection tank 400, while preventing the waste water from flowing into the cleaning tank 200 and contaminating the cleaning tank 200.

In some embodiments, the water scraping plate of this embodiment is arranged on a side of the collection tank 400 facing away from a rotation direction of the cleaning member, and a projection of at least a portion of the water scraping plate overlaps with a projection of the collection tank 400 in a plane parallel to the bottom wall 210 of the cleaning tank. That is, in the vertical direction, the water scraping plate has a portion that overlaps with the collection tank 400. The side of the collection tank 400 facing away from the rotation direction of the cleaning member is the side of the collection tank 400 that comes into contact with a reference point from behind when the cleaning member is rotated and cleaned within the cleaning tank 200, which reference point is a specific point on the cleaning member.

In this embodiment, by arranging the water scraping plate on the side of the collection tank 400 facing away from the rotation direction of the cleaning member, the water scraping plate can scrape the waste water from the cleaning member to the collection tank 400 after contact with the rotating cleaning member, thereby facilitating the flow of the waste water into the collection tank 400. By arranging at least a portion of the water scraping plate within the projection of the collection tank 400, the water scraping plate has a portion that overlaps with the collection tank 400 in the vertical direction, such that the waste water scraped by the water scraping plate can fall directly into the collection tank 400.

In some embodiments, the water scraping plate of this embodiment is connected to and integrally formed with a tank wall of the collection tank 400. The integral formation of the water scraping plate and the tank wall of the collection tank 400 can help simplify the manufacturing process and improve the production efficiency.

In some embodiments, the water scraping plate of this embodiment extends in a direction perpendicular to the bottom wall 210 of the cleaning tank. The arrangement of the water scraping plate perpendicular to the bottom wall 210 of the cleaning tank can ensure that the water scraping plate has a good water scraping efficiency.

With continued reference to FIGS. 1, 3, 4, 5 and 7, in an embodiment, in order to adapt a cleaning device having two cleaning members, the cleaning tank 200 of this embodiment includes a first tank body 201 and a second tank body 202 arranged side by side, the collection tank 400 is arranged between the first tank body 201 and the second tank body 202, and the collection tank 400 is in communication with both the first tank body 201 and the second tank body 202. Communication means that there is a path between each of the first tank body 201 and the second tank body 202 and the collection tank 400 that allows water or other dirt to pass therethrough, thereby facilitating the discharge of the water or other dirt from the first tank body 201 and the second tank body 202 into the collection tank 400.

In this embodiment, the collection tank 400 is arranged between the first tank body 201 and the second tank body 202, to facilitate the collection of the waste water from the cleaning member located in the first tank body 201 and from the cleaning member located in the second tank body 202 into the collection tank 400.

Further, as shown in FIG. 4, the water scraping plate includes a first water scraping plate 310 located on the first tank body 201 and a second water scraping plate 320 located on the second tank body 202, the collection tank 400 includes a first tank wall 401 and a second tank wall 402 on a side facing away from a rotation direction of the cleaning member, the first water scraping plate 310 is flush with the first tank wall 401, and the second water scraping plate 320 is flush with the second tank wall 402. In this embodiment, the first water scraping plate 310 can scrape the waste water from the cleaning member in the first tank body 201 into the collection tank 400, and the second water scraping plate 320 can scrape the waste water from the cleaning member in the second tank body 202 into the collection tank 400.

Specifically, the cleaning member of this embodiment may include a first cleaning member and a second cleaning member. For example, from a top view of the base station, the first cleaning member is located on the left side of the base, and the second cleaning member is located on the right side of the base. The first cleaning member rotates counterclockwise and the second cleaning member rotates clockwise during cleaning of the cleaning members. The first water scraping plate 310 and the second water scraping plate 320 are formed at a side wall of the collection tank 400 close to an entrance of the cleaning base station 1000, such that during rotation of the cleaning members, the waste water scraped by the first water scraping plate and the second water scraping plate can flow directly into the collection tank. Specifically, in the cleaning tank 200 shown in FIG. 4, the first cleaning member in the first tank body 201 may rotate clockwise such that the waste water on the first cleaning member in the first tank body 201 is scraped into the collection tank 400 by the first water scraping plate 310; and the second cleaning member in the second tank body 202 may rotate counterclockwise such that the waste water on the second cleaning member in the second tank body 202 is scraped into the collection tank 400 by the second water scraping plate 320.

In other possible implementations, the first cleaning member in the first tank body 201 may rotate counterclockwise and the second cleaning member in the second tank body 202 may rotate clockwise. In this case, the first water scraping plate 310 and the second water scraping plate 320 may be accordingly formed at a side wall of the collection tank 400 away from the entrance of the cleaning base station 1000. This also enables the waste water from the first cleaning member and the second cleaning member to be scraped into the collection tank 400.

In an embodiment, a projection of the first tank body 201 and a projection of the second tank body 202 are both sector-shaped or circular in a plane parallel to the bottom wall 210 of the cleaning tank, to be suitable for cleaning circular cleaning members. At least a portion of the collection tank 400 is located within a radial range of the first tank body 201 and a radial range of the second tank body 202, so as to facilitate scraping of the waste water from the cleaning member into the collection tank 400.

In some embodiments, a friction member is further provided on the bottom wall 210 of the cleaning tank of this embodiment, and the cleaning member can be in contact with the bottom wall 210 of the cleaning tank and the friction member. By providing the friction member, the cleaning member can be in contact with the friction member and the bottom wall 210 of the cleaning tank. When the cleaning member is in contact with the friction member, the friction force between the cleaning member and the bottom wall 210 of the cleaning tank can be increased, thereby improving the cleaning efficiency of the cleaning member. When the cleaning member is in contact with the bottom wall 210 of the cleaning tank, the bottom wall 210 of the cleaning tank can be cleaned. Compared with the solutions in the related art, in the present application, during use, since the overall height of the cleaning tank 200 within the base 100 is raised, the friction member on the bottom wall 210 of the cleaning tank can come into contact with the cleaning member during cleaning of the cleaning member, thereby enhancing the cleaning effect on the cleaning member. Compared with the solutions in the related art, the enhanced cleaning effect of this embodiment may cause more dirt to remain on the bottom wall 210 of the cleaning tank. In view of the fact that the cleaning member is in contact with the bottom wall 210 of the cleaning tank in this embodiment, while the cleaning member is being cleaned, the bottom wall 210 of the cleaning tank is simultaneously cleaned by using the cleaning member, to reduce the amount of dirt remaining on the bottom wall 210 of the cleaning tank.

As shown in FIGS. 1, 3 and 4, in some embodiments, the friction member of this embodiment includes a plurality of protrusions 510 protruding from the bottom wall 210 of the cleaning tank. The plurality of protrusions 510 may be uniformly arranged on the bottom wall 210 of the cleaning tank. By uniformly arranging the plurality of protrusions 510 on the bottom wall 210 of the cleaning tank, the rotating cleaning member can be scrubbed with the protrusions 510, thereby improving the cleaning efficiency of the cleaning member.

Specifically, the plurality of protrusions 510 include a plurality of protruding points formed at the bottom wall 210 of the cleaning tank, the plurality of protruding points being uniformly distributed over at least a portion of the bottom wall 210 of the cleaning tank. For example, when the cleaning tank 200 is sector-shaped or circular, the plurality of protruding points may be arranged in a plurality of circular rings, and the distance between two adjacent protruding points in the same circular ring is equal to the distance between two adjacent protruding points in adjacent circular rings, thereby enabling even scrubbing of the rotating cleaning member and improving the cleaning efficiency of the cleaning member.

Further, the plurality of protruding points may also be integrally formed with the cleaning tank 200 to facilitate increased productivity.

The cleaning base station 1000 of this embodiment further includes a water circuit assembly to implement the water supply and drainage function of the cleaning base station 1000. As shown in FIG. 2, in some embodiments, the water circuit assembly includes a water inlet pipeline 600. The water inlet pipeline 600 includes a water inlet 610 and a water inlet pipe 620. The water inlet pipe 620 is configured to communicate with a water source, which may be a clean water tank in the cleaning base station 1000, or other water sources (e.g., a tap water pipe) outside the cleaning base station 1000. The water inlet 610 is formed at one end of the water inlet pipe 620, and the water inlet 610 is in communication with the cleaning tank 200 or the collection tank 400, so that clean water supplied by the water source can flow through the water inlet pipe 620 and the water inlet 610 into the cleaning tank 200 or the collection tank 400. In this embodiment, by providing the water inlet pipeline 600, the clean water from the water source is introduced into the cleaning tank 200 or the collection tank 400, thereby enabling the cleaning of the cleaning member.

As shown in FIGS. 1, 3 and 4, in some embodiments, a scoop wheel 410 is rotatably provided in the collection tank 400 of this embodiment. The scoop wheel 410 is configured to scoop the water from the collection tank 400 onto the cleaning member above the cleaning tank 200. In this embodiment, by providing the rotatable scoop wheel 410, the water in the collection tank 400 is scooped onto the cleaning member by means of the scoop wheel 410, thereby achieving water reuse, improving the utilization rate of water, facilitating a reduction in the water consumption during cleaning of the cleaning member, and conserving water resources. In addition, the collection tank 400 is shared by the clean water and the waste water, and thus the space of the base can be saved. It is also possible to prevent liquid from splashing upward to wet the cleaning member, thus avoiding wetting the cleaning base station 1000. With the above solution, the liquid level in the collection tank 400 can be made a little lower, and the liquid can be carried by the scoop wheel 410 to avoid spillage of the liquid from the collection tank 400.

Further, the scoop wheel 410 of this embodiment includes a rotatable wheel body 411. The wheel body 411 has a plurality of blades arranged in a circumferential direction. The blades are configured to be driven to rotate with a rotational movement of the cleaning member to scoop the water from the collection tank 400 onto the cleaning member above the cleaning tank 200. The wheel body 411 of this embodiment may partially protrude from the bottom wall 210 of the cleaning tank. When the cleaning member is rotated in the cleaning tank 200, the cleaning member can drive the scoop wheel 410 to rotate synchronously within the collection tank 400. A recessed structure is formed between two adjacent blades on the scoop wheel 410, such that the water is scooped onto the cleaning member by means of the recessed structure between the two adjacent blades to improve the utilization rate of water. In this embodiment, the scoop wheel 410 is rotated by the cleaning member, without the need for a separate driving structure, thereby facilitating cost reduction and ease of implementation. The scoop wheel 410 can provide a continuous and uniform liquid output to ensure a continuous supply of liquid to the cleaning member.

In other possible embodiments, the wheel body 411 may be provided with a plurality of grooves arranged in an axial direction of the wheel body 411. The plurality of grooves are spaced apart along the circumferential direction of the wheel body 411. When the cleaning member is rotated in the cleaning tank 200, the cleaning member can drive the scoop wheel 410 to rotate synchronously within the collection tank 400, and the water can be scooped onto the cleaning member by means of the grooves on the scoop wheel 410 to improve the utilization rate of water.

In this embodiment, the rotation of the scoop wheel 410 is driven by the rotation of the cleaning member, without the need for a separate driving structure for the scoop wheel 410, thereby simplifying the structure of the cleaning base station 1000.

In some embodiments, the scoop wheel 410 of this embodiment is removably arranged in the collection tank 400. The removable arrangement of the scoop wheel 410 in the collection tank 400 facilitates subsequent maintenance and replacement, and also facilitates daily cleaning of the scoop wheel 410 by the user.

By way of example, as shown in FIG. 3, the scoop wheel 410 further includes connecting pins 412 arranged at two axial ends of the wheel body 411, and the collection tank 400 is provided with two connecting grooves 420 arranged opposite to each other. The connecting pins 412 are seated in the corresponding connecting grooves 420 to allow for a removable connection between the scoop wheel 410 and the collection tank 400.

With continued reference to FIG. 2, in some embodiments, the water circuit assembly of this embodiment further includes a drain pipeline 700. The drain pipeline 700 includes a drain port 710 and a drain pipe 720. The drain pipe 720 is configured to communicate with a waste discharge device, which may be a waste water tank in the cleaning base station 1000, or other apparatuses outside the cleaning base station 1000. The drain port 710 is formed at one end of the drain pipe 720, and the drain port 710 is in communication with the collection tank 400, so that the waste water in the collection tank 400 can flow into the waste discharge device through the drain port 710 and the drain pipe 720. In this embodiment, the drain pipeline 700 is configured to drain the waste water from the collection tank 400, so that the circulation of water in the cleaning tank 200 is achieved with the incorporated water inlet pipeline 600.

As shown in FIGS. 5 and 7, in some embodiments, a filter screen 430 is further provided in the collection tank 400 of this embodiment. The filter screen 430 is configured to cover the drain port 710. In this embodiment, by providing the filter screen 430, large-sized dirt particles in the waste water can be intercepted to avoid blockage of the drain pipeline 700.

In an embodiment, the filter screen 430 is removably arranged in the collection tank 400 to facilitate installation and removal, and to facilitate timely disposal of dirt at the filter screen 430 to avoid blockage.

With continued reference to FIGS. 1-4, in one possible embodiment, the water source of this embodiment may be the clean water tank of the cleaning base station 1000, the water inlet 610 is located in the collection tank 400, and the water inlet 610 is arranged between the first water scraping plate 310 and the second water scraping plate 320, that is, between the first tank wall 401 connected to the first water scraping plate 310 and the second tank wall 402 connected to the second water scraping plate 320. The waste discharge device may be the waste water tank of the cleaning base station 1000, and the drain port 710 is located in the collection tank 400 on a side away from the water inlet 610. That is, the cleaning base station 1000 of this embodiment is provided with a clean water tank and a waste water tank, so that the circulation of water within the cleaning base station 1000 can be achieved without the need for external apparatuses. Further, the incorporated scoop wheel structure enables the base station to consume less water, thereby decreasing the frequency of replacing the clean water tank and the waste water tank by the user.

In an embodiment, the water inlet 610 of this embodiment is arranged to face away from the guide plate such that the water flowing out of the water inlet 610 is flushed to the rear of the cleaning base station 1000, and is thus prevented from sputtering outside the cleaning base station 1000.

In a specific embodiment, the water source of this embodiment may be the clean water tank of the cleaning base station 1000, the waste discharge device may be the waste water tank of the cleaning base station 1000, and the scoop wheel 410 is rotatably arranged in the collection tank 400, so that the water in the collection tank 400 can be repeatedly scooped up and used by means of the scoop wheel 410, thereby helping to conserve water and reduce the frequency of replacing the water tanks by the user.

Further, as shown in FIGS. 2 and 4, a projection of the water inlet 610 of this embodiment is sector-shaped in a plane parallel to the bottom wall 210 of the cleaning tank. In this embodiment, by configuring the water inlet 610 to have a sector-shaped cross section, the water inlet 610 can spray a wider surface of water, thereby flushing more areas within the collection tank 400. When the waste water in the collection tank 400 is drained, the water inlet 610 can be opened to flush the collection tank 400 so as to clean the residual dirt in the collection tank 400.

In an embodiment, a high-pressure spray head, which is connected to the water inlet 610, may be provided to improve the cleaning effect on the collection tank 400. In this way, the water inlet 610 can both replenish water to the cleaning member and clean the collection tank 400 by means of the high-pressure spray head, thereby achieving functional reuse and facilitating implementation.

In a direction away from the water inlet pipe 620, the size of the water inlet 610 gradually increases. As can be appreciated in connection with the figures, the position where the water inlet 610 is connected to the water inlet pipe 620 is slit-like, such that the clean water sprayed from the water inlet 610 has a higher initial velocity, thereby sending the clean water to a farther position within the collection tank 400, to facilitate the cleaning of the collection tank 400.

With continued reference to FIG. 2, the drain port 710 of this embodiment is arranged on the bottom wall 403 of the collection tank, and the bottom wall 403 of the collection tank is inclined from the water inlet 610 to the drain port 710. In this embodiment, by configuring the bottom wall 403 of the collection tank to be inclined from the water inlet 610 toward the drain port 710, the waste water can flow to the drain port 710 under the force of gravity, so that the waste water can be drained from the collection tank 400.

In an embodiment, the drain port 710 may be arranged at the lowest point of the bottom wall of the collection tank 400 to avoid residue during drainage.

With continued reference to FIG. 4, the first tank wall 401 and the second tank wall 402 of this embodiment are inclined, and a distance between the first tank wall 401 and the second tank wall 402 gradually increases from the water inlet 610 to the drain port 710. In this embodiment, the first tank wall 401 and the second tank wall 402 are inclined and the distance between the first tank wall 401 and the second tank wall 402 gradually increases in the direction away from the water inlet 610, so that the water inlet 610 with a sector-shaped cross section can be incorporated to further raise the water pressure sprayed into the collection tank 400, thereby facilitating better cleaning of the residual dirt in the collection tank 400.

By way of example, the drain pipe 720 of this embodiment is further connected to a control valve configured to control the opening and closing of the drain pipe 720. The control valve controls the disconnection of the drain pipe 720 from the waste discharge device when the cleaning member is cleaned such that the water in the collection tank 400 is not drained. With the incorporated scoop wheel 410, the water in the collection tank 400 is reused, and when the water in the collection tank 400 is contaminated to a certain extent, the control valve is opened to drain the waste water from the collection tank 400, thereby making full use of water resources and helping to conserve water consumption. Specifically, the water in the collection tank 400 can be periodically replaced according to the drainage time. Alternatively, a dirt sensor may be provided to detect the degree of dirt to determine when to replace the water in the collection tank 400.

With continued reference to FIGS. 5-8, in another possible embodiment, the water inlet 610 of this embodiment may be located in the cleaning tank 200, and the drain port 710 may be located in the collection tank 400. In this embodiment, the cleaning base station 1000 may be provided with a water source such as a clean water tank and a waste discharge device such as a waste water tank, so that the cleaning base station 1000 can circulate water by itself without the need for other external apparatuses. Alternatively, the water inlet pipeline 600 and the drain pipeline 700 of the cleaning base station 1000 may be in communication with external apparatuses to achieve the circulation of water in conjunction with the external apparatuses.

Further, as shown in FIGS. 5 and 7, the friction member of this embodiment further includes a plurality of ribs 520. The ribs 520 protrude from the bottom wall 210 of the cleaning tank, and the water inlet 610 is located on a side of the rib 520 facing away from the rotation direction of the cleaning member. In other words, during rotation, the cleaning member first comes into contact with the side of the rib 520 not provided with the water inlet 610, then crosses the highest point of the rib 520, and then comes into contact with the side of the rib 520 provided with the water inlet 610.

Further, the plurality of ribs smoothly transition into the bottom wall of the cleaning tank such that the cleaning member can contact the bottom wall of the cleaning tank and the ribs when rotating relative to the cleaning tank.

In this embodiment, by arranging the water inlet 610 on the side of the rib 520 facing away from the rotation direction of the cleaning member, the blockage of the water inlet 610 can be effectively prevented, thereby ensuring that the water inlet 610 has good water inlet capacity.

It will be appreciated that in this embodiment, a plurality of protrusions 510 as described in the above embodiments may be also provided between two adjacent ribs 520, thereby further increasing the friction force on the cleaning member to improve the cleaning efficiency of the cleaning member.

As shown in FIG. 5, the water inlet 610 of this embodiment may be arranged in the direction of extension of the rib 520. The arrangement of the water inlet 610 in the direction of extension of the rib 520 can increase the water inlet area of the water inlet 610, thereby facilitating the wetting of a larger area of the cleaning member, and facilitating an improvement in the cleaning efficiency.

As shown in FIGS. 7 and 8, each of the ribs 520 of this embodiment may be further provided with a water guide portion 530. The water guide portion 530 includes a water guide bottom wall 531, a first water guide sidewall 532 and a second water guide sidewall 533. The first water guide sidewall 532 and the second water guide sidewall 533 are both located on the water guide bottom wall 531, a first end of the first water guide sidewall 532 and a first end of the second water guide sidewall 533 are close to each other, the water inlet 610 is located between the first end of the first water guide sidewall 532 and the first end of the second water guide sidewall 533, and a spacing between the first water guide sidewall 532 and the second water guide sidewall 533 gradually increases in a direction away from the water inlet 610.

In this embodiment, since the rib 520 is provided with the water guide portion 530, and the spacing between the first water guide sidewall 532 and the second water guide sidewall 533 of the water guide portion 530 gradually increases in the direction away from the water inlet 610, the water drained from the water inlet 610 can be uniformly spread out by the water guide portion 530 and then comes into contact with the cleaning member, so as to more uniformly wet the cleaning member, thereby facilitating an improvement in the cleaning efficiency.

With continued reference to FIGS. 5 and 7, the plurality of ribs 520 of this embodiment include a plurality of first ribs 521 located in the first tank body 201 and a plurality of second ribs 522 located in the second tank body 202. The plurality of first ribs 521 are uniformly arranged in a circumferential direction of the first tank body 201, and the plurality of second ribs 522 are uniformly arranged in a circumferential direction of the second tank body 202. The first water scraping plate 310 is arranged on the first rib 521 on a side of the collection tank 400 facing away from the rotation direction of the cleaning member, and the second water scraping plate 320 is arranged on the second rib 522 on the side of the collection tank 400 facing away from the rotation direction of the cleaning member.

In this embodiment, the plurality of first ribs 521 are uniformly arranged in the first tank body 201, and the cleaning member in the first tank body 201 can be uniformly supported by the plurality of first ribs 521, so as to prevent the cleaning member from being unevenly subjected to force. The plurality of second ribs 522 are uniformly arranged in the second tank body 202, and the cleaning member in the second tank body 202 can be uniformly supported by the plurality of second ribs 522, so as to prevent the cleaning member from being unevenly subjected to force.

In some embodiments, the cleaning tank 200 of this embodiment is removably arranged on the base 100. In this embodiment, the removable arrangement of the cleaning tank 200 on the base 100 facilitates subsequent maintenance and replacement, and also facilitates daily maintenance of the cleaning tank 200 by the user.

As shown in FIG. 3, by way of example, the base 100 of this embodiment is provided with a mounting recess 110, a positioning protrusion 120 is provided in the mounting recess 110, and a surface of the cleaning tank 200 facing the mounting recess 110 is provided with a positioning groove. The positioning groove of the cleaning tank 200 is sleeved over the positioning protrusion 120.

In this embodiment, the cleaning tank 200 can be removably arranged on the base 100 by mating the positioning groove of the cleaning tank 200 with the positioning protrusion 120 of the mounting recess 110.

The positioning groove has a positioning column 220 formed on the surface of the cleaning tank 200 facing away from the mounting recess 110, and the cleaning member may cooperate with the positioning column 220 to achieve the positioning, preventing the cleaning member from shaking when rotating within the cleaning tank 200.

In some embodiments, the cleaning tank 200 of this embodiment may be a stainless steel tank. The stainless steel cleaning tank 200 is resistant to dirt adhesion and facilitates easier cleaning with the cleaning member. The cleaning tank 200 may also be made of other materials that are resistant to dirt adhesion and are easy to clean.

In some embodiments, the cleaning tank 200, the water scraping structure 300, and the collection tank 400 of this embodiment may be integrally formed, for example, may be integrally injection molded with a mold, thereby facilitating increased productivity.

This embodiment further provides a cleaning system, including a cleaning device and the cleaning base station 1000 as described above. The cleaning device includes a first cleaning member and a second cleaning member, which are arranged side by side on the cleaning device. The cleaning device can be driven into the cleaning base station 1000 to clean the cleaning members on the cleaning device.

In this embodiment, after the cleaning device is driven into the cleaning base station 1000, the bottom wall 210 of the cleaning tank comes into contact with the cleaning member when the cleaning member is cleaned, and the cleaning member can simultaneously clean the cleaning tank 200 during the process in which the cleaning member is rotated and cleaned within the cleaning tank 200. By providing the collection tank 400 and the water scraping structure 300, the water scraping structure 300 can scrape the dirt from the cleaning member into the collection tank 400 during the process in which the cleaning member is rotated and cleaned within the cleaning tank 200, thereby reducing the amount of dirt remaining on the surface of the cleaning tank 200 after the cleaning member is cleaned in the cleaning base station 1000, reducing the subsequent workload of a user, and facilitating an improvement in the user experience.

In the description of the present application, it should be understood that orientation or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential”, etc. are based on orientation or position relationships shown in the accompanying drawings and are merely for ease of description of the present application and simplification of the description, rather than indicating or implying that the devices or elements referred to must have a specific orientation or be constructed and operated in a specific orientation, and therefore cannot be construed as limiting the present application.

In the present application, unless expressly stated or limited otherwise, the terms such as “mounting”, “connecting”, “connection” and “fixing” should be interpreted broadly, for example, either fixed or detachable connection, or integration; may be a direct connection or an indirect connection by means of an intermediate medium, or may be internal communication between two elements or interaction between the two elements. For those of ordinary skill in the art, the specific meaning of the terms mentioned above in the present application should be construed according to specific circumstances.

It should be noted that the terms “first” and “second” described in the present application are only for the convenience of describing different components and should not be understood as indicating or implying a sequential relationship and relative importance or implicitly indicating the number of technical features indicated. Therefore, the features defined with “first” and “second” may explicitly or implicitly include at least one of the features.

The embodiments or implementations in the present application are described in a progressive manner, each embodiment focuses on the difference from other embodiments, and for the same or similar parts of the embodiments, reference can be made to each other.

In the description of the present application, the description with reference to the terms such as “one implementation”, “some implementations”, “an illustrative implementation”, “an example”, “a specific example” or “some examples” means that the specific features, structures, materials, or characteristics described with reference to the implementation or example are included in at least one implementation or example of the present application. In the present application, the illustrative expressions of the above terms do not necessarily refer to the same embodiments or examples. In addition, the specific features, structures, materials or characteristics described may be combined in any one or more embodiments or examples in an appropriate manner.

Finally, it should be noted that the above embodiments are merely used for illustrating rather than limiting the technical solution of the present application. Although the present application has been illustrated in detail with reference to the foregoing embodiments, it should be understood by those of ordinary skill in the art that the technical solutions described in the foregoing embodiments may still be modified, or some or all of the technical features thereof may be equivalently substituted; and these modifications or substitutions do not make the essence of the corresponding technical solution depart from the scope of the technical solutions of the embodiments of the present application.

What is claimed is:

1. A cleaning base station for cleaning a cleaning member of a cleaning device, the cleaning base station comprising:
a base;
a cleaning tank arranged on the base and configured to at least partially accommodate the cleaning member, a bottom wall of the cleaning tank being in contact with the cleaning member when the cleaning member is cleaned;
a collection tank, the collection tank being in communication with the cleaning tank; and
a water scraping structure arranged in the cleaning tank or the collection tank, the collection tank being configured to receive dirt scraped off by the water scraping structure.

2. The cleaning base station according to claim 1, wherein the cleaning member is rotatable relative to the cleaning tank, at least one of the cleaning member and the cleaning tank is capable of being cleaned when the cleaning member rotates relative to the cleaning tank, and waste water on the cleaning member is scraped off by the water scraping structure.

3. The cleaning base station according to claim 2, wherein the water scraping structure comprises a water scraping plate, the water scraping plate protruding from the bottom wall of the cleaning tank and being adjacent to the collection tank.

4. The cleaning base station according to claim 3, wherein the water scraping plate is arranged on a side of the collection tank facing away from a rotation direction of the cleaning member, and a projection of at least a portion of the water scraping plate overlaps with a projection of the collection tank in a plane parallel to the bottom wall of the cleaning tank.

5. The cleaning base station according to claim 3, wherein the water scraping plate is connected to and integrally formed with a tank wall of the collection tank, and the water scraping plate extends in a direction perpendicular to the bottom wall of the cleaning tank.

6. The cleaning base station according to claim 3, wherein the cleaning tank comprises a first tank body and a second tank body arranged side by side, the collection tank is arranged between the first tank body and the second tank body, and the collection tank is in communication with both the first tank body and the second tank body.

7. The cleaning base station according to claim 6, wherein the water scraping plate comprises a first water scraping plate located on the first tank body and a second water scraping plate located on the second tank body, the collection tank comprises a first tank wall and a second tank wall on a side facing away from a rotation direction of the cleaning member, the first water scraping plate is flush with the first tank wall, and the second water scraping plate is flush with the second tank wall.

8. The cleaning base station according to claim 7, wherein the first water scraping plate and the second water scraping plate are formed at a tank wall of the collection tank close to an entrance of the cleaning base station.

9. The cleaning base station according to claim 6, wherein a projection of the first tank body and a projection of the second tank body are both sector-shaped or circular in the plane parallel to the bottom wall of the cleaning tank, and at least a portion of the collection tank is located within a radial range of the first tank body and a radial range of the second tank body.

10. The cleaning base station according to claim 7, further comprising a water circuit assembly comprising a water inlet pipeline, the water inlet pipeline comprising a water inlet and a water inlet pipe, wherein the water inlet pipe is configured to communicate with a water source, the water inlet is formed at one end of the water inlet pipe, and the water inlet is in communication with the cleaning tank or the collection tank.

11. The cleaning base station according to claim 10, wherein the water inlet is located in the collection tank, a scoop wheel is rotatably provided in the collection tank, and the scoop wheel is configured to scoop water from the collection tank onto the cleaning member above the cleaning tank;
wherein the scoop wheel comprises a rotatable wheel body, the wheel body having a plurality of blades arranged in a circumferential direction, the blades being configured to be driven to rotate with a rotational movement of the cleaning member to scoop the water from the collection tank.

12. The cleaning base station according to claim 10, wherein the water circuit assembly further comprises a drain pipeline, the drain pipeline comprising a drain port and a drain pipe, wherein the drain pipe is configured to communicate with a waste discharge device; and the drain port is formed at one end of the drain pipe, and the drain port is in communication with the collection tank.

13. The cleaning base station according to claim 12, wherein the water inlet is arranged between the first water scraping plate and the second water scraping plate; and
the drain port is located in the collection tank on a side away from the water inlet.

14. The cleaning base station according to claim 10, wherein a friction member is further provided on the bottom wall of the cleaning tank, and the cleaning member is capable of contacting the bottom wall of the cleaning tank and the friction member when rotating relative to the cleaning tank;
wherein the friction member comprises a plurality of protrusions protruding from the bottom wall of the cleaning tank.

15. The cleaning base station according to claim 14, wherein the plurality of protrusions comprise a plurality of protruding points formed at the bottom wall of the cleaning tank, the plurality of protruding points being uniformly distributed over at least a partial region of the bottom wall of the cleaning tank.

16. The cleaning base station according to claim 14, wherein the water inlet is located in the cleaning tank, the friction member further comprises a plurality of ribs, the ribs protruding from the bottom wall of the cleaning tank, and the water inlet is located on a side of the rib facing away from the rotation direction of the cleaning member.

17. The cleaning base station according to claim 16, wherein the water inlet is in the form of an elongated hole provided in the rib.

18. The cleaning base station according to claim 16, wherein each of the ribs is further provided with a water guide portion, the water guide portion comprising a water guide bottom wall, a first water guide sidewall and a second water guide sidewall, wherein the first water guide sidewall and the second water guide sidewall are both located on the water guide bottom wall, a first end of the first water guide sidewall and a first end of the second water guide sidewall are close to each other, the water inlet is located between the first end of the first water guide sidewall and the first end of the second water guide sidewall, and a spacing between the first water guide sidewall and the second water guide sidewall gradually increases in a direction away from the water inlet.

19. The cleaning base station according to claim 16, wherein the plurality of ribs comprise a plurality of first ribs located in the first tank body and a plurality of second ribs located in the second tank body, the plurality of first ribs being uniformly arranged in a circumferential direction of the first tank body, and the plurality of second ribs being uniformly arranged in a circumferential direction of the second tank body, wherein the first water scraping plate is arranged on the first rib on a side of the collection tank facing away from the rotation direction of the cleaning member, and the second water scraping plate is arranged on the second rib on the side of the collection tank facing away from the rotation direction of the cleaning member.

20. A cleaning system, comprising a cleaning device and a cleaning base station according to claim 1, wherein the cleaning device comprises a first cleaning member and a second cleaning member, the first cleaning member and the second cleaning member being arranged side by side on the cleaning device.
